(19) United States
(12) Patent Application Publication
(10) Pub. No.: US 2007/0261692 A1
(43) Pub. Date: Nov. 15, 2007

(54) Thermostatic Temperature Control for Self-Heating Containers

(75) Inventors: Michael Sheppard Bolmer, Sarasota, FL (US); Yan Xiong, Clearwater, FL (US); Kevin J. Pitz, Ruskin, FL (US); R. Paul Zbigniew, University Park, FL (US); Martin W. Sabin, Sarasota, FL (US); Cullen M. Sabin, Bradenton, FL (US)

Correspondence Address: FISH & RICHARDSON P.C., P.O. BOX 1022, MINNEAPOLIS, MN, 55440-1022, US

(73) Assignee: Tempra Technology, Inc., Bradenton, FL (US)

(21) Appl. No.: 11/568,683

(22) PCT Filed: May 5, 2005
(86) PCT No.: PCT/US05/15793

§ 371 Date: Jul. 27, 2007

Related U.S. Application Data
(60) Provisional application No. 60/568,644, filed on May 6, 2004.

(51) Int. Cl. F24J 1/00; A62C 3/00

(52) U.S. Cl. 126/263.01; 169/46

(57) ABSTRACT

A system and method for protecting self-heating containers that include single-use chemical heaters during overtemperature occasions includes the automatic release into the heater of a suppressant composition in response to a design temperature being achieved. For protection against extreme temperature excursions, the system and method include generating steam to absorb heat and venting that steam.

### TECHNICAL FIELD

This invention relates to single-use heaters and self-heating product containers employing the same to heat foods, beverages and other products for consumption or use upon user-initiation of an exothermic chemical reaction.

### BACKGROUND

Self-heating product containers with single-use chemical heaters and employing user-initiated chemical heating are well known. U.S. Pat. Nos. 5,461,867 and 5,626,022, for example, disclose single-use heaters employing the exothermic hydration of calcium oxide. U.S. Pat. No. 5,035,230 discloses single-use heaters employing the reaction of a polyol fuel such as ethylene glycol with an oxidizing agent such as potassium permanganate. Following activation by a user to cause the mixing of reaction components, chemical heaters produce a fixed quantity of heat and thereby cause a temperature rise dependent on the rate of heat generation by the reaction and the rate of heat loss from the heater to the product being heated and, to one extent or another, to the surroundings. Depending on the chemical reaction employed, there are methods and materials that may be employed in heater manufacture to tailor the rate and duration of an exothermic reaction to achieve a desired magnitude of temperature rise in the product being heated.

For certain uses known chemical heaters have commercial deficiencies and, in some cases, potential safety problems. For example, a self-heating container that increases a product's temperature by a fixed amount will yield a final product temperature starting at 0° C. ambient that is about 20° C. lower than the final product temperature achieved starting at 20° C. ambient. If the heater for that container and product is sized to produce a desired product temperature starting from 20° C. ambient, the product temperature may be unacceptably low if the ambient temperature drops to 0° C. Conversely, if the heater is sized to produce the desired product temperature starting from 0° C. ambient, the product temperature may be unacceptably high if the ambient temperature increases to 20° C. An unacceptably high product temperature may pose a scalding risk. Unacceptably high product temperatures and container temperatures also will result from partial or complete absence of product resulting from premature product removal or spillage, which is particularly a risk for a liquid product such as a beverage or a soup. Without the heat sink provided by the product being heated, the temperature in the reaction chamber of the heater may rise to a level at which reactants or reaction products degrade. The temperature level may be moderated to a degree in such situations by including water in the reaction mixture, thereby holding the temperature to the boiling point until all water is evaporated. Even so, extreme temperature excursions may cause the container to become sufficiently hot to pose a burn risk to the user. Further, including sufficient water in the reaction to absorb through its boiling all the heat generated tends to reduce the rate of heat generation to an unacceptably low level during normal operation.

Aspects of this invention have applicability to systems and methods for suppressing the exothermic reactions of single-use chemical heaters in rigid or semi-rigid self-heating containers, that is, heaters and containers that are shape-retaining as well as in flexible pouches containing thermally coupled heating and product compartments. An aspect of this invention is a method for automatically suppressing an exothermic reaction in a single-use chemical heater in thermal contact with the product compartment of a self-heating container by releasing, preferably by injecting, into the heater's reaction chamber a suppressant composition in response to a selected temperature being reached at the product compartment, thereby slowing or even terminating the exothermic reaction.

Another aspect of this invention is venting steam generated during extreme temperature excursions in addition to automatically releasing suppressant into the reaction zone.

A further aspect of this invention is a self-heating container having a single-use chemical heater thermally coupled to a product compartment further comprising an automatic suppressant system that includes an isolated compartment containing suppressant composition and means, responsive to a selected temperature condition at the product compartment, for automatically releasing, preferably injecting, the suppressant composition into the reaction zone of the heater.

Yet another aspect of this invention is a self-heating container including sufficient water in the suppressant system to limit any temperature excursion to the steam boiling point in the system and further including means for venting steam from the heater, preferably venting steam through a diffuser.

### SUMMARY

This invention includes methods and systems for suppressing the heat generation rate and consequent temperature rise of activated single-use chemical heaters and rigid, semi-rigid or flexible self-heating containers employing them. Methods and systems according to this invention can be designed to provide differing amounts of suppression, from modest moderation to complete suppression, and to be operative in responsive to selected temperature conditions in order to accommodate particular heaters, containers and products.

According to this invention a suppressant composition is automatically released into the heat-generating chamber of a chemical heater, thereby moderating or suppressing the reaction, in response to a selected temperature condition associated with overheating.

Heaters useful with suppression systems and methods of this invention are single-use heaters that generate heat by an exothermic reaction resulting from mixing of reaction components upon initiation by a user. Such a single-use heater includes a reaction chamber, which may be and typically is a chamber in which one reactant resides prior to initiation. A second reactant resides in a separate sealed chamber prior to use, whereby premature reaction is prevented. A user initiates the exothermic reaction by compromising the separation of the reactants, which then mix in the reaction zone forming a reaction mixture that either is a liquid or includes a liquid phase. This invention is not limited in its applicability to heaters employing any particular exothermic reaction. It may be applied, for example, to calcium oxide heaters, which generate heat when the reactants calcium oxide and water are combined in a reaction mixture. Our preferred heaters utilize the exothermic reaction between a polyol fuel, such as ethylene glycol, and an oxidizing agent. Preferred oxidizing agents are alkali metal permanganates, for example, potassium permanganate.

User initiation of a heater may be by any suitable mechanical means, such as opening a valve or compromising a frangible seal separating the second reactant, or even each reactant if desired, from the reaction zone. Initiation means may include a push button, a pull tab or a screw action, among others. The reaction zone may be separate and apart from the original reactant-containing zones or compartments, or the reaction zone may be one or more of the original reactant-containing zones.

Self-heating containers to which this invention is applicable include a single-use heater as described above and at least one product compartment for containing a beverage, a food product or another product to be heated. For ease of understanding, this invention will be described in terms of a single product compartment, it being understood that multiple product compartments may be employed and that multiple compartments may each be served by at least one chemical heater or one heater may serve multiple product compartments. The product compartment is a closed or closable compartment that can be opened by a user. It may be, for example, a cylindrical beverage or food container fabricated from metal or food-grade plastic or laminated materials. It may also be other shapes, such as a bowl, a plate or a box, as may be appropriate for a particular product. It may be flexible or shape-retaining. The heater may be constructed of any material that will safely contain the heating reaction. Its reaction chamber preferably is shape-retaining, that is, of rigid or semi-rigid construction, but may be flexible in certain embodiments. Flexible compartments such as elastomeric bags may be included in the heaters as will be described. Heaters, including heaters with suppressant systems according to this invention, may be fabricated separately from product compartments and then physically joined to create a self-heating container. Alternatively, heaters and product compartments may be fabricated, for example, molded, wholly or partly as a unit. In either case the reaction chamber includes a surface, typically a major surface, in thermal contact with a product compartment surface, which is thermally coupled to the product compartment whereby heat generated flows to the product compartment and into the product being heated. Typically thermal coupling is achieved either by abutting heat-conducting walls of the heater's reaction chamber and the product compartment or by utilizing a single heat-conducting wall separating the product compartment from the reaction chamber. The release of the suppressant is coupled with the product temperature and not with the reaction temperature. The heating reaction typically achieves a high temperature rapidly, and a suppressant released when this temperature is achieved would tend to suppress the reaction at the same elapsed time, giving a constant heat rise independent of the product temperature. In certain embodiments other heater surfaces may have insulating capability or be provided with insulation, at least surfaces exposed to normal user contact.

Self-heating containers according to this invention include a suppressant compartment for storing a suppressant composition and from which the suppressant composition may be automatically released into the reaction mixture in response to a prescribed temperature being reached at the product compartment. The suppressant compartment may be a closed compartment or separate chamber located within the reaction chamber of the heater. It may be a fusible solid that surrounds a volume for suppressant composition or into which suppressant composition may be dispersed. In the latter case the fusible solid serving as the meltable compartment holding the suppressant may be applied as a coating to the inside of the reaction chamber thermally coupled to the product compartment, for example. Alternatively the suppressant compartment may be located outside the reaction chamber but in fluid communication with that chamber and, hence, with the reaction mixture upon release. In all cases the suppressant compartment serves to separate physically the suppressant composition from the heater's reaction mixture prior to release.

Self-heating containers according to this invention include a release mechanism to release the stored suppressant composition into the reaction chamber automatically in response to an overtemperature condition having occurred or being in the process of occurring or possibly occurring at the product compartment surface thermally coupled to the heater's reaction chamber. For example, if the heater is designed to heat the product to a desired final temperature, say 60° C., starting from 0° C. ambient temperature, it will be necessary to suppress the exothermic reaction when the ambient temperature is higher. Because suppression is not instantaneous, one preferably would design the suppression system to release the suppressant composition when the temperature at the indicated product compartment surface approaches the level correlative with the desired final product temperature such that continued heating following the release of suppressant composition will achieve the desired final product temperature. The released suppressant composition would slow or stop the reaction to hold the final product temperature down, if the starting temperature is higher, say 20° C., thus yielding the same or nearly the same final product temperature beginning from quite different ambient temperatures. The appropriate control temperature can be ascertained empirically for a particular container and product.

In preferred embodiments release of the suppressant is thermally responsive. Our preferred automatic temperature-responsive control means is a fusible component that is thermally coupled to a surface of the product compartment and melts at a selected temperature. A fusible component may comprise all or a portion of the suppressant compartment or a means restraining suppressant release. It may be a metal alloy that melts at a selected temperature. Such alloys and their design are well known from their use in fire sprinklers. A fusible metal allow may be employed as a fusible link that prevents release of suppressant composition while it is solid but causes or permits release upon melting. For example, a fusible link thermally coupled to a product compartment surface may be used to restrain a spring-loaded dart or to plug a discharge line from a suppressant compartment. Wax that melts at a selected temperature is another example of a fusible component, as is commonly used in safety valves on water heaters. Wax may be used as a fusible link or used to contain suppressant composition and to release it upon melting. Other temperature-responsive control means may also be used. For example, one may utilize the thermal expansion of a bimetallic element, as is commonly used in thermostats, particularly a snapping bimetallic element of the circular, domed variety. Alternatively, automatic release may be indirectly responsive to an overtemperature condition, that is, directly responsive to another physical parameter correlative with such condition. For example, in some embodiments a pressure rise in the reaction chamber may correlate with product temperature, in which event a pressure-responsive mechanism may be utilized to release the suppressant composition.

Preferred methods and systems of this invention cause released suppressant composition to flow into the reaction chamber irrespective of the orientation of the self-heating container. If one considers a release that includes, for example, an opening of a port or hole in the bottom of the suppressant compartment, the suppressant composition will not flow, if the container is in an inverted position. We refer to the preferred systems as causing suppressant composition to be “injected” into the reaction chamber and to the preferred methods as “injecting” suppressant composition into that chamber, by which is meant that the released suppressant is caused to flow into the chamber where it can contact at least the liquid reactants no matter what is the orientation of the container. A preferred embodiment includes storing the suppressant composition in an elastomeric bag that is under tension as a separate compartment inside the reaction chamber, and puncturing the bag to release the composition, whereby the bag fails catastrophically like the bursting of a balloon, ensuring that the composition leaves the bag and enters the reaction chamber. Another means for injecting suppression composition is to store it under pressure in a compartment having an exit tube to the reaction chamber that is releasably blocked, as by a fusible link functioning as a plug. The compartment need not be elastomeric in such an embodiment. It could be, for example, a rigid cylinder that contains a spring-loaded piston capable of forcibly ejecting suppressant composition once the exit blockage is removed. Another preferred embodiment includes storing the suppressant composition in a fusible material, such as wax, that is inside the reaction chamber and thermally coupled to the product compartment, whereby release is automatically into the reaction chamber.

Suppressant compositions may contain a liquid that does not react with the heater's heat-generating reactants and whose addition to the reaction mixture therefore dilutes the mixture, slowing the reaction, and absorbs heat. The preferred diluent component of suppressant compositions is water. In cases of extreme thermal excursion, as occurs when product is removed prior to initiation of the exothermic reaction or shortly thereafter, the added water also provides a large heat sink, namely, its latent heat of vaporization. Thus, water in a suppressant composition not only slows an exothermic reaction but also provide a replacement heat sink for missing product when needed. As will be appreciated, added water places a pressure-dependent upper limit on the reaction chamber temperature as long as it is vaporizing. Sufficient water is included to suppress boiling while some water still remains, thereby capping the magnitude of the temperature excursion.

Suppressant compositions may include materials that complex with the reactants. For example, boric acid or borax rapidly forms a complex with polyhydroxy compounds, such as glycerol, used with permanganates in a redox reaction. Once the reactants are in a complex, they will not react as rapidly. A complex that is in equilibrium with its constituent components will slowly release the reactants so that all or a selected reactant will be safely consumed, totally deactivating the heater for disposal. A suppressant may be a precipitating agent that causes one of the reactants to precipitate out of the reacting solution. A suppressant may be a catalyst poison that stops the activity of the catalyst in a catalyzed reaction, leaving the reactants to react at their much slower uncatalyzed rate. A suppressant may hinder diffusion and thereby prevent the reactants from contacting each other, for example: gelling agents, crystallizing agents, or defoaming agents. Selecting suppressant compositions is within the skill of the art. A suppressant composition may be of a type and in an amount sufficient to stop the exothermic reaction in the reaction chamber. Depending on the application, however, a suppressant composition may be of a type and in an amount sufficient to moderate the exothermic reaction to the desired extent but not to completely stop the reaction. For example, it may be desired that the reaction be greatly slowed, even nearly stopped, but continue slowly so as to use up at least one of the reactants while generating heat at a rate sufficiently low not to cause an unacceptably high temperature.

For embodiments intended to protect against extreme temperature excursions which cause steam to be generated, heaters and self-heating containers according to this invention include means for venting steam from the reaction chamber. Such means may include a relief valve, which may be as simple as a port blocked with a fusible plug, responsive to temperature of the reaction chamber, or plug or weakened wall area sensitive to increased pressure. Venting means for self-heating beverage containers may include a vent tube extending from a location in the reaction chamber above the heat-generating reaction mixture, as supplemented with suppressant composition, through a wall of the reaction chamber and preferably into a steam diffuser which distributes the exiting steam, slowing its velocity, and, if desired, passing it through a filter to remove entrapped solids and liquids. If a self-heating container includes an outer insulation layer, steam may be passed into that layer. Because boiling tends to create foam, a heater for a self-heating beverage container may include a steam plenum in which the feed end of the vent tube is located, and may further include a diffuser to deflect foam away from the tube's feed end.

A variety of mechanisms may be employed to release suppressant compositions, and this invention is not limited to any particular mechanism. One suitable mechanism is a spring-loaded sharpened blade, for example, a dart, that can be released to puncture the compartment or chamber containing suppressant composition, including but not limited to a stretched elastomeric bag. Control of such a mechanism is preferably a fusible link restraining release. Another mechanism is a fusible metal alloy link used as a plug to prevent release of the suppressant composition and to release the composition on melting, that is, a temperature controlled valve or plug. Similarly, a variety of control means may be employed to cause release of suppressant composition. Our preferred mechanism is a fusible material thermally coupled to the product compartment. The solid link may prevent operation of a release mechanism until it melts or, as noted above, the link itself may be the release mechanism. Wax-based fusible elements may be used.

In certain preferred embodiments the suppressant compartment itself may be the release mechanism, so that when the compartment itself fails, for example melts, at a design temperature, suppressant composition is released. The suppressant may be mixed with nonreactive low-melting material, for example, wax so that as the material melts the entrapped suppressant is released. This is particularly useful for solid suppressants, as a wax-suppressant mixture may be placed directly inside the reaction chamber in thermal contact with the product being heated, where it will remain compartmentalized and hence inactive until the wax melts. In embodiments of this type, the wax or other low-melting-temperature material serves as the compartment for the suppressant and also as a temperature-dependent fusible component and release mechanism. Thermal contact with the product being heated may be achieved, for example, by applying a wax compartment containing suppressant composition as a coating on the inside heater surface adjacent to the product compartment. Because melting of such a compartment releases suppressant in the reaction chamber, this is an example of an injection method and apparatus. Another possibility for controlled release is a snapping bimetallic element. All of the foregoing are temperature-dependent and respond directly to temperature. However, in some cases one may utilize a release mechanism whose operation depends indirectly on temperature, as a pressure-operated mechanism where pressure in the reaction chamber correlates to product temperature.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a simplified vertical cross sectional view of a self-heating container according to this invention.

FIGS. 2a and 2b are cutaway side views of a release mechanism for the suppressant according to this invention before and after activation, respectively.

FIG. 3 is a simplified vertical cross sectional view of the self-heating container used in the examples.

FIG. 4 is a graph showing temperature readings over time for products heated in Examples 1-12.

FIG. 5 is a graph of temperature over time of a simulated calcium oxide heater both with and without release of suppressant composition.

Like reference symbols in the various drawings indicate like elements.

### DETAILED DESCRIPTION

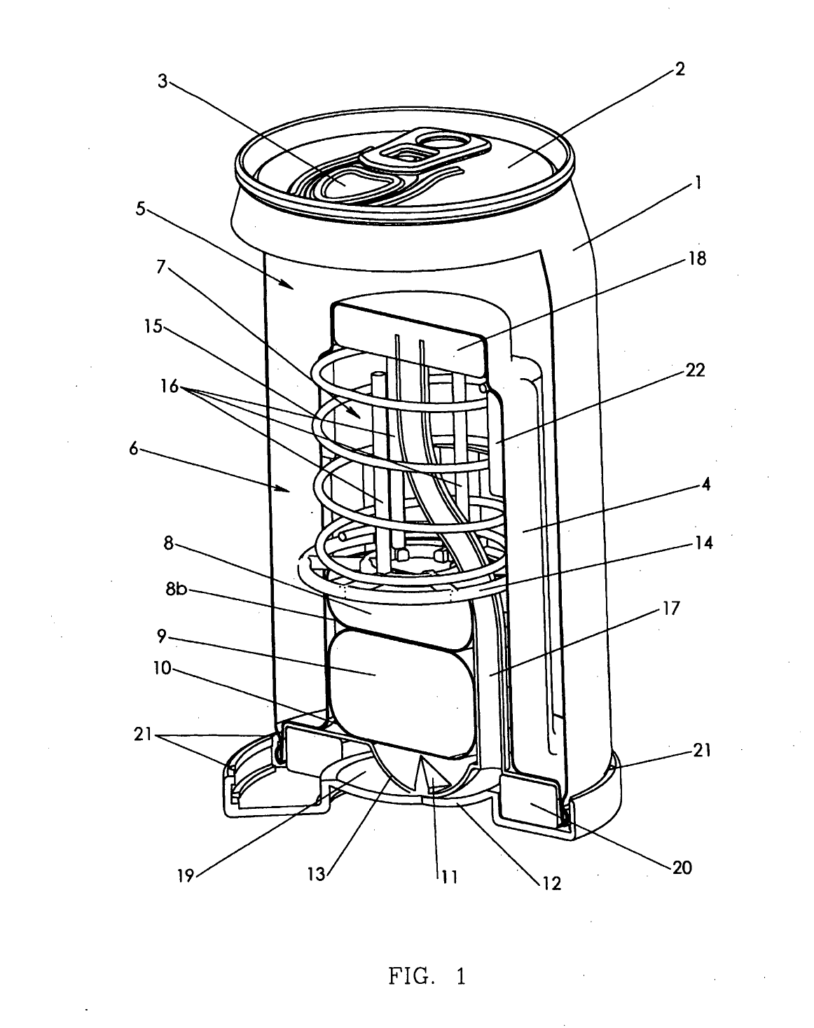

FIG. 1 presents a simplified view of a self-heating container that includes a suppressant system according to this invention. The container comprises an outer wall 1 and a top 2 with means for opening 3. Inside the container is a wall 4. The wall 4 is sealed to the outer wall 1 to provide a closed beverage chamber 5, which contains the beverage 6 and wall 4 forms a closed reaction chamber 7. The first reactant 8 is placed inside the closed chamber 7. The second reactant 9 is placed inside a sealed pouch 10.

A point 11 is provided to pierce the pouch 10. The point 11 is activated by pressing on the outer dome 12 on the bottom of the container. This in turn presses on inner dome 13, which comprises the bottom of reaction chamber 7. As the inner dome 13 is pressed upward, the point 11 ruptures the pouch 10. A frame 14 is pressed down by spring 15, and this causes the second reactant 9 to exit the pouch 10, causing the two reactants 8 and 9 to come in contact and react. Standoffs 16 prevent the pouch 10 from rising when the point 11 rises, which would avoid rupturing the pouch 10.

When the two reactants 8 and 9 react, they produce heat, which is transferred through wall 4, heating the beverage 6 inside chamber 5.

As the contents of reaction chamber 7 heat, gas pressure builds up. This is vented through vent 17. A filter 18 prevents liquids and solids from entering and blocking vent 17. At the end of the vent 17 is a plenum 19 between the two domes 12 and 13, where the vent gas is distributed. The gas then passes through a second filter 20, and finally is released to the atmosphere through multiple vent channels 21. The filter 20 also prevents external contaminants from entering the plenum 19, the vent 17, or the reaction chamber 7.

A solid mixture 22 of a fusible compound and a suppressant is provided in reaction chamber 7 in contact with the inner surface of the reactor wall 4. When the reaction is initiated, this mixture 22 is above and not in contact with the reactants 8 and 9. As the beverage 6 becomes heated, heat is transferred through wall 4 back into this part of the reaction chamber 7 where the reaction is not taking place. This heats the mixture 22 until the fusible component reaches its melting point. Then the mixture 22 becomes detached from the wall 4 and the suppressant comes into contact with the reactants, suppressing the reaction.

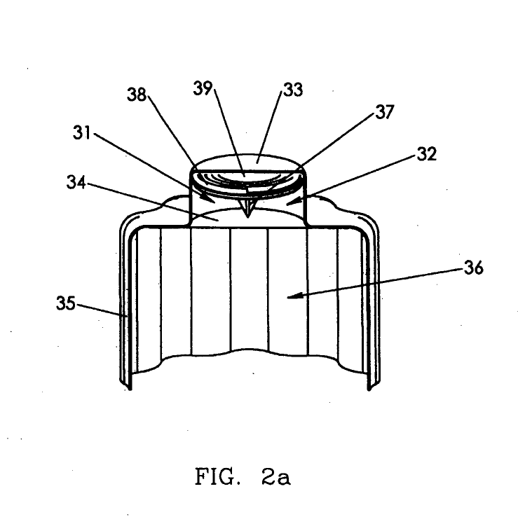

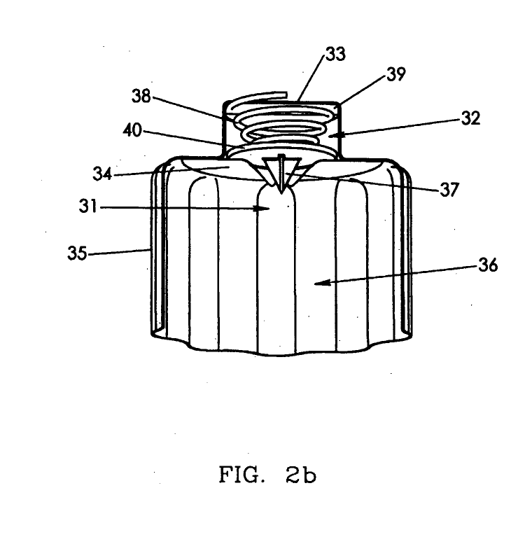

FIGS. 2a and 2b show a release mechanism for the suppressant: FIG. 2a shows before activation, and FIG. 2b shows after activation. In FIG. 2a the suppressant 31 is inside a chamber 32 formed by a dome 33 and a foil seal 34. The dome 33 is part of wall 35 forming the reaction chamber 36. Dome 33 and wall 35 are in contact with material being heated, similarly to wall 4 shown in FIG. 1. There is no communication between the two chambers 32 and 36 before activation. A point 37 is attached to spring 38. The spring 38 is held in a compressed configuration by a fusible means or link 39, which is in contact with the dome 33.

In FIG. 2b when the dome 33 becomes heated the fusible means 39 melts, releasing the spring 38. The spring 38 forces the point 37 through the foil seal 34. The flat base 40 of the point 37 expels the suppressant 31 into the reaction chamber 36. The fusible means 39 remains in the chamber 32.

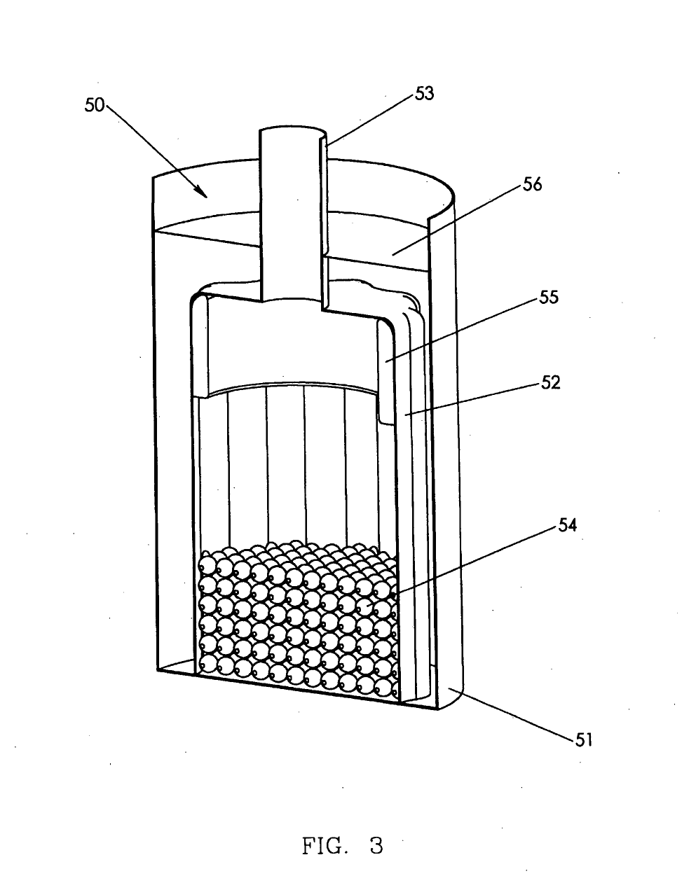

FIG. 3 shows an experimental self-heating container apparatus used in the Examples described below. It is comprised of a copper cylinder with a bottom 51. Inside cylinder 51 is a second cylinder 52 attached to the bottom of cylinder 51 to form a water-tight seal. The wall of cylinder 52 is fluted to increase the heat transfer surface area. There is a vent stack 53 attached to the top of cylinder 52 to form a water-tight seal. A solid reactant 54 is shown inside cylinder 52. A solid mixture 55 of suppressant (for example, boric acid-wax paste or the borax-wax paste) is pressed against the inside walls of cylinder 52 at the top so that it does not contact the solid 54. A product, for example, a beverage, to be heated 56 (or a simulated product such as water) is placed in the space 50 between the two cylinders 51 and 52, which form a product compartment.

Suppressant compositions useful in the systems and methods of this invention include water, water-based solutions and water-based dispersions. Suppressant compositions useful in this invention also include dry composition such as granules and powders. Preferred compositions include boric acid in a ratio to the polyhydroxy fuel component between about 0.1 and about 2.0, preferably between 0.5 and 1.0; or borax in a ratio to the polyhydroxy fuel component between about 0.1 and about 2.0, preferably between 0.5 and 1.0. We prefer that, in composition and amount, the suppressant composition stops boiling of the heat-generating reaction mixture, and greatly slows but does not completely stop the reaction, so that over time all of a selected at least one of the reactants will be consumed. Preferred designs generate sufficient heat to raise the temperature of the product to a desired level starting from the lowest ambient temperature expected or otherwise chosen as a design parameter. If it is desired that the final product temperature be the same starting from higher ambient temperatures, release of suppressant composition will need to occur when the product reaches a temperature somewhat lower than the final design temperature, because reaction shut-down is not instantaneous. The temperature will not stop climbing immediately. Some trial and adjustment will be required to optimize a suppression system for a particular product and self-heating container combination.

### EXAMPLES

Thermostatic temperature control according to this invention has been demonstrated utilizing a cylindrical can body, a heater module upwardly insertable into the can body, and water as the product in the product compartment formed by the can body and the outside of the heater module. As shown by the following examples, both solid and liquid suppressant compositions can be released into the heat-generating chemical reaction at selected temperatures to moderate the effect on final product temperature caused by variation in starting temperature.

### Example 1

To the heater module 52 of a test can according to the FIG. 3 was added 34 g of solid potassium permanganate (KMnO₄) 54. 210 ml of water 56 were placed inside the beverage compartment of the can 50. No suppressant 55 was included. The can and its contents were cooled in a refrigerator to 7° C. Thirty-two ml of 30% glycerol in water were placed in a syringe, and this was placed in the refrigerator and cooled. The can and syringe were removed from the refrigerator and two thermocouples were placed inside the water 56. The contents of the syringe were injected into the heater module through the vent 53, wetting the permanganate. The glycerol reacted with the permanganate and heated the can and the water. When the water 56 reached 43° C., 5 g of borax (Na₂B₄O₇.10H₂O) were added into the reaction chamber through the vent 53. The water temperature after 8 minutes was 64° C.

### Example 2

A second can and syringe were filled as in Example 1, but they were not placed in a refrigerator. They remained at ambient temperature, which was 23° C. When the liquid fuel solution was injected, the glycerol reacted with the permanganate and heated the can and the water. When the water reached 43° C., 5 g of borax (Na₂B₄O₇.10H₂O) were added into the reaction chamber through the vent. The water was heated from 23° C. to 66° C.

### Example 3

A third can was filled as in Example 1, except that the water 56 was heated. After the water was placed in the can, it was left to stand so that the can and permanganate could equilibrate with the water to the same temperature: 38° C. The room-temperature liquid fuel solution was injected, and the glycerol reacted with the permanganate and heated the can and the water. When the water 56 reached 43° C., 5 g of borax (Na₂B₄O₇.10H₂O) were added into the reaction chamber through the vent. The water heated from 38° C. to 66° C.

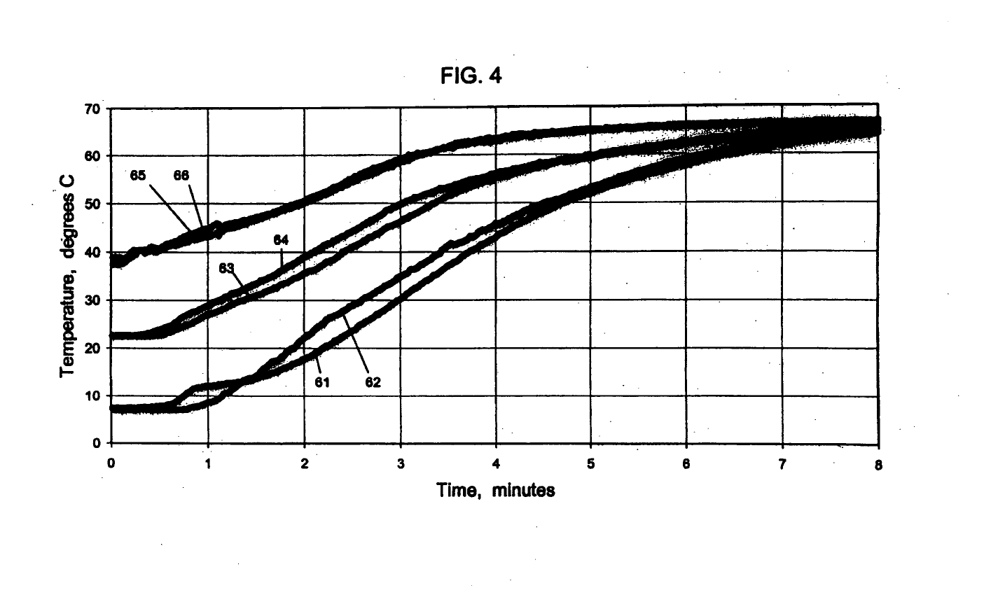

The temperatures of the two thermocouples in the water were monitored during the course of the heating in Examples 1, 2, and 3. FIG. 4 shows the temperatures of the two thermocouples in the water during the course of the heating in Examples 1, 2, and 3. The temperatures in Example 1 are 61 and 62; the temperatures in Example 2 are 63 and 64; and the temperatures in Example 3 are 65 and 66. While the three cans started about 31° C. apart, they ended up only about 2° C. apart.

### Example 4

The heater module of a can according to the FIG. 3 was filled with 40 g potassium permanganate (KMnO₄) 54. 5 g of borax (Na₂B₄O₇.10H₂O) and 5 g of paraffin wax with a melting point of 53° C. were mixed into a paste. The paste was applied as a coating 55 to the top half of the inside of the heater module, where it was in thermal contact with the beverage 56. 210 ml of water 56 were placed inside the beverage compartment of the can. The can and its contents were cooled in a refrigerator to 7° C. Thirty-two ml of 30% glycerol in water and 2 ml of a silicone defoaming agent were placed in a syringe, and this was placed in the refrigerator and also cooled. The can and syringe were removed from the refrigerator and two thermocouples were placed inside the water 56. The contents of the syringe were injected into the heater module through the vent 53, wetting the permanganate. The glycerol reacted with the permanganate and heated the can and the water. The water temperature after 10 minutes was 68° C.

### Example 5

A second can and syringe were filled as in Example 4, but they were not placed in a refrigerator. When the liquid fuel solution was injected, the water heated from 21° C. ambient temperature to 68° C.

### Example 6

A third can was filled as in example 4, except that the water was heated. After the water was placed in the can, it was left to stand so that the can and permanganate could equilibrate with the water to the same temperature: 38° C. The room-temperature liquid solution was injected, and the water heated from 38° C. to 73° C.

The temperatures of the two thermocouples in the water were monitored during the course of the heating in Examples 4, 5, and 6. While the three cans started about 31° C. apart, they ended up only about 5° C. apart.

### Example 7

The heater module of a can according to the FIG. 3 was filled with 36 g potassium permanganate (KMnO₄) 54. 7.5 g of boric acid (H₃BO₃) and 7.5 g of paraffin wax with a melting point of 46° C. were mixed into a paste. The paste was applied as a coating 55 to the top half of the inside of the heater module, where it was in thermal contact with the beverage 56. 210 ml of water 56 were placed inside the beverage compartment of the can. The can and its contents were cooled in a refrigerator to 7° C. Thirty-two ml of 33% glycerol in water were placed in a syringe, and this was placed in the refrigerator and cooled. The can and syringe were removed from the refrigerator and two thermocouples were placed inside the water 56. The contents of the syringe were injected into the heater module through the vent 53, wetting the permanganate. The glycerol reacted with the permanganate and heated the can and the water. The water temperature after 8 minutes was 64° C.

### Example 8

A second can and syringe were filled as in Example 7, but they were not placed in a refrigerator. When the liquid solution was injected, the water heated from 22° C. ambient temperature to 68° C.

### Example 9

A third can was filled as in example 7, except that the water 56 was heated. After the water was placed in the can, it was left to stand so that the can and permanganate could equilibrate with the water to the same temperature: 38° C. The room-temperature liquid solution was injected, and the water heated from 38° C. to 78° C.

The temperatures of the two thermocouples in the water were monitored during the course of the heating in Examples 7, 8, and 9. While the three cans started about 31° C. apart, they ended up about 14° C. apart.

### Example 10

The heater module of a can according to the FIG. 3 was filled with 36 g potassium permanganate (KMnO₄). 210 ml of water were placed inside the beverage compartment of the can. The can and its contents were cooled in a refrigerator to 8° C. Thirty-two ml of 33% glycerol in water were placed in a syringe, and this was placed in the refrigerator and cooled. The can and syringe were removed from the refrigerator and two thermocouples were placed inside the water. The contents of the syringe were injected into the heater module through the vent 53, wetting the permanganate. The glycerol reacted with the permanganate and heated the can and the water. When the water reached 43° C., 20 ml of water were added into the reaction chamber through the vent 53. The water temperature after 8 minutes was 69° C.

### Example 11

A second can and syringe were filled as in Example 10, but they were not placed in a refrigerator. When the liquid fuel solution was injected, the glycerol reacted with the permanganate and heated the can and the water. When the water reached 43° C., 20 ml of water were added into the reaction chamber through the vent. The water was heated from 22° C. ambient temperature to 71° C.

### Example 12

A third can was filled as in example 10, except that the water 56 was heated. After the water was placed in the can, it was left to stand so that the can and permanganate could equilibrate with the water to the same temperature: 38° C. The room-temperature liquid fuel solution was injected, and the glycerol reacted with the permanganate and heated the can and the water. When the water reached 43° C., 20 ml of water were added into the reaction chamber through the vent. The water heated from 38° C. to 83° C.

The temperatures of the two thermocouples in the water were monitored during the course of the heating in Examples 10, 11, and 12. While the three cans started 30° C. apart, they ended up only about 14° C. apart.

### Example 13

Calcium oxide was prepared by oven-decomposing calcium carbonate in the form of 6-10 mm natural rock particles. The water used for the tests was de-ionized. The material employed to suppress the hydration reaction between the calcium oxide and the water was saturated sodium , silicate solution, 41 degrees Baume.

The reaction took place in a 100 cc glass beaker, which was placed on a cloth pad to decrease heat losses to the laboratory bench. The top was covered with aluminum foil pierced for insertion of a thermocouple. Otherwise the reaction vessel was not insulated.

Two runs were made. In both runs about 20 grams of calcium oxide were reacted with 20 cc of water. This ratio of ingredients yielded a product which was damp and putty-like, but which had no free water standing in it. In the second run, 5 cc of the saturated sodium silicate solution was added when the reactor reached about 38° C.

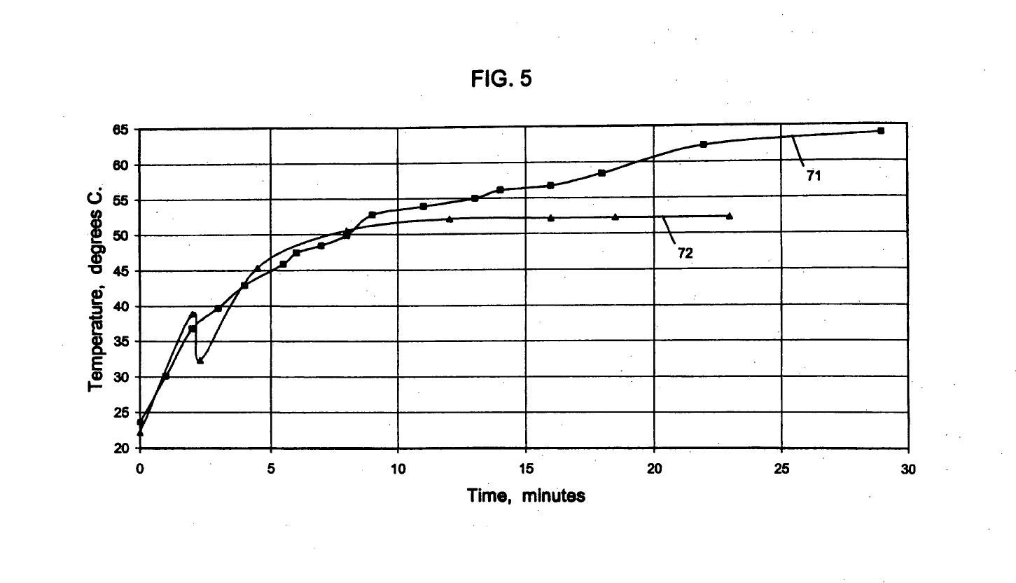

The results of these tests are shown in FIG. 5. Temperature readings over time from a thermocouple place in the reactor during the first run are shown in line 71. Temperature readings over time from the thermocouple during the second run are shown as line 72. It may be seen that the reaction continued to produce heat in the first run after the temperature passed 38° C., leading to a final temperature of 64° C. It may be seen that, in contrast, the reaction in the second run, in which the sodium silicate solution was added, ceased after a short period of time, as indicated by a leveling off of the temperature at 52° C. At the end of the second run, an undetermined amount of liquid water was still in the reaction vessel.

The experiments reported in this example demonstrate suppression of the reaction of a calcium oxide heater. Release of the suppressant composition could be made responsive to a product temperature by the means and method of this invention. Although not wishing to be bound by any theory, we believe that the mechanism by which the sodium silicate solution stops the reaction is probably as follows. Saturated sodium silicate solution, which is very viscous at room temperature, is readily diluted in hot water. When the solution is added to the reactor, it rapidly mixes, and the mixture enters the zone from which the calcium oxide is drawing its water. The reaction then draws the water out of the silicate solution. The solution dehydrates, leaving a sodium silicate coating over the surface of the calcium oxide-hydroxide particles. The heating reaction, deprived of the water necessary for its continuance, ceases. Line 72 of FIG. 5 shows that the reaction continues for a short time after the solution is added. This is attributed to the fact that a layer of reacting water continues to be available to the reaction until the silicate layer can form.

A number of embodiments of the invention have been described. Nevertheless, it will be understood that various modifications may be made without departing from the spirit and scope of the invention. Accordingly, other embodiments are within the scope of the following claims.

1. A method for suppressing an exothermic reaction in a self-heating container that includes a single-use chemical heater in which reactants generate heat in a reaction chamber thermally coupled to a product compartment comprising
(a) providing the container with a releasable reaction suppressant composition, and
(b) in response to a selected temperature occurring at the product compartment, automatically releasing the suppressant composition into the reaction chamber, thereby suppressing the exothermic reaction.

2. The method according to claim 1 wherein the suppressant composition includes water.

3. The method according to claim 1 wherein the suppressant composition includes at least one ingredient selected from the group of a catalyst poison, a complexing agent, a crystallizing agent, a defoaming agent, a gelling agent, and a precipitating agent.

4. The method according to claim 1 wherein the step of automatically releasing the suppressant composition includes injecting the suppressant composition into the reaction chamber.

5. The method according to claim 1 wherein the step of automatically releasing the suppressant composition is thermally responsive.

6. The method according to claim 5 wherein the step of automatically releasing the suppressant composition includes melting a fusible component thermally coupled to the product compartment.

7. The method according to claim 6 wherein the suppressant composition is dispersed in a fusible component applied to the inside of the reaction chamber.

8. The method according to claim 5 wherein the suppressant composition is provided in an elastomeric bag under tension, and the step of automatically releasing the suppressant composition includes puncturing said bag.

9. The method according to claim 1 wherein the exothermic reaction is not completely terminated by the released suppressant composition.

10. The method according to claim 1, wherein the exothermic reaction generates steam, comprising the additional step of venting steam from the reaction chamber.

11. The method according to claim 10 wherein the steam is diffused while being vented.

12. The method according to claim 10 wherein the steam is filtered while being vented.

13. A self-heating container including a product compartment physically separate from but in thermal contact with a reaction chamber of a single-use chemical heater, wherein the container additionally includes a reaction-suppression system comprising
(a) a suppressant composition in a releasably closed compartment having fluid communication with the reaction chamber, and
(b) means, responsive to a selected temperature being reached by the product compartment, for automatically releasing the suppressant composition into the reaction chamber.

14. The container according to claim 13 wherein the suppressant composition includes water.

15. The container according to claim 13 wherein the suppressant composition includes at least one ingredient selected from the group of a catalyst poison, a complexing agent, a crystallizing agent, a defoaming agent, a gelling agent, and a precipitating agent.

16. The container according to claim 13, wherein the means for releasing suppressant composition includes a fusible component thermally coupled to the product compartment.

17. The container according to claim 16 wherein the releasably closed compartment and the means for releasing comprise the fusible component containing dispersed suppressant composition on the inside of the reaction chamber.

18. The container according to claim 13 further including means for injecting released suppressant composition into the reaction chamber irrespective of the orientation of the container.

19. The container according to claim 18 wherein the means for injecting includes an elastomeric suppression composition compartment under tension inside the reaction chamber and a releasable mechanism for rupturing the bag when released.

20. The container according to claim 14 further comprising means for venting steam from the reaction chamber.

21. The container according to claim 14 wherein the means for venting steam includes a vent tube projecting into the reaction chamber and a deflector for preventing foam from entering the vent tube.

22. The container according to claim 20 wherein said means for venting steam includes a steam diffuser.

23. The container according to claim 13 wherein the chemical heater and reaction-suppressing system comprise a unitary structure sealably insertable into a product container.
